(19) United States
(12) Patent Application Publication
(10) Pub. No.: US 2018/0289055 A1
(43) Pub. Date: Oct. 11, 2018

(54) Magnetic Cigarette Filters And Related Methods

(71) Applicant: Ray Dion Moreno, Riverbank, CA (US)

(72) Inventor: Ray Dion Moreno, Riverbank, CA (US)

(21) Appl. No.: 16/003,061

(22) Filed: Jun. 7, 2018

Related U.S. Application Data
(63) Continuation-in-part of application No. 15/893,529, filed on Feb. 9, 2018.
(60) Provisional application No. 62/457,043, filed on Feb. 9, 2017.

(51) Int. Cl. A24D 3/06

(52) U.S. Cl. CPC A24D 3/067; B09B 5/00; A24D 3/062

(57) ABSTRACT

A magnetic filter device for use with a cigarette, the magnetic filter device capable of being gathered from loose or uneven ground surfaces via a magnet. The magnetic filter device may comprise a filter element, a wrapping element, and a magnetic element e.g., a ferrous metal), the magnetic element being a layer between the filter and the rolling paper, integrated into the rolling paper, or integrated or inserted into the material of the filter.

### PRIORITY CLAIM

This application is a continuation-in-part of pending U.S. patent application Ser. No. 15/893,529, filed on Feb. 9, 2018, which is a non-provisional of U.S. Provisional Application No. 62/457,043, and this application claims the benefit of each application, and incorporates each application herein by this reference in its entirety.

### FIELD OF THE INVENTION

The present invention relates to improved disposable smoke filters. More particularly, embodiments of the present invention pertain to cigarette filters with magnetic elements which can be collected from the ground after use via a magnet.

### DISCUSSION OF THE BACKGROUND

Cigarettes typically include filters on their non-lit ends for the purposes of filtering particulates out of the smoke being inhaled and providing an extension for a person to hold when the cigarette has burned down near to that end. These filters are disposable and are intended to be deposited in a waste receptacle. However, after a cigarette has been smoked, the leftover filters often end up on the ground. This situation is undesirable for several reasons. Cigarette filters thrown on the ground can end up washed into storm drains and into waterways, they can be ingested by wildlife—for which they are toxic—and they can create an eye-sore in public parks, beaches, gutters, and on construction sites.

Existing methods for cleaning up discarded cigarette filters from the ground include sweeping them up, gathering them with a blower, or picking them up by hand. When filters are discarded onto uneven ground (e.g., a lawn or living ground cover), or onto loose material (e.g., sand, gravel, or bark ground cover), gathering the filters a broom or a blower is ineffective. Further, regularly picking up large numbers of discarded filters by hand is an inefficient process, and often costs more in labor than a business or public authority is willing to spend.

It is therefore desirable to provide an improved apparatus and methods for efficiently and effectively gathering cigarette filters discarded onto uneven or loose ground surfaces.

### SUMMARY OF THE INVENTION

The present invention relates to an improved apparatus and related methods for gathering discarded cigarette filters. Embodiments of the present invention provide a magnetic filter device which can be gathered from loose or uneven ground surfaces via a magnet. The magnetic filter device may comprise a magnetic element (e.g., a metal) integrated into the rolling paper, integrated or inserted into the material of the filter itself, or as a layer between the filter and the rolling paper.

The magnetic element may be scalable in size such that it may be utilized with any size of cigarette filter, or may be utilized with a cigar butt. The magnetic element may have a shape which is operable to be inserted into pre-manufactured cigarettes. The magnetic element may be utilized for inhalable substances other than tobacco smoke (e.g., a disposable mouthpiece filter for a vapor device, or a filter for a marijuana cigarette). The magnetic element may also be integrated into an end of the rolling paper of a filterless cigarette. The magnetic element may even be integrated into wrappings for other consumables which often end up on the ground (e.g., candy wrappers).

The magnetic element may allow for the gathering of a plurality of discarded filters (or wrappers) from an uneven surface by passing a magnet over the filters (e.g., via a pole having a magnet on a distal end thereof). The filters may then be transferred from the magnet to a waste receptacle.

The magnetic filter device of the present invention may comprise a filter element, a wrapping element, and a magnetic element. The filter element may comprise any material capable of filtering particulate matter or toxins from an inhalable substance (e.g., cellulose acetate fibers or activated charcoal). In some embodiments, the filter element may comprise a polymer material having a microporous or matrix-like composition. In other embodiments, the filter element may comprise a paper having molecular sieves. In yet other embodiments, the filter element may comprise fibers having small particle size absorbent material (e.g., carbon or silica). In some embodiments, the filter element may comprise a commercially available filter. The filter element may comprise a cylindrical shape.

The wrapping element may comprise any combustible material suitable to envelop and secure a filter element and a combustible filler (e.g., tobacco). In some embodiments, the wrapping element may comprise a paper material. In some embodiments, the paper material may comprise thin and lightweight paper made from non-wood plant fibers (e.g., flax, hemp, sisal, rice straw, or esparto). In some embodiments, the wrapping element may be transparent. In other embodiments, the wrapping element may be opaque and colored. In some embodiments, the wrapping element may have a porosity suited to the type of combustible filler in the cigarette, and may contain additives to regulate a burning rate. In some embodiments, the wrapping element may comprise an adhesive (e.g., sugar gum) on an edge thereof, the adhesive being operable to hold the edge of the wrapping element in place when wrapped about the filter element. The wrapping element may comprise a commercially available rolling paper used for making cigarettes.

The magnetic element may comprise any material capable of being magnetized or attracted by a magnet. In some embodiments, the magnetic element may comprise a ferromagnetic material (e.g., iron, nickel, cobalt, steel, or other similar magnetic alloy or composition). In some embodiments, the magnetic element may be a composition comprising both magnetic and non-magnetic components. In some embodiments, the magnetic element may comprise a thin, laminar shape operable to be wrapped around at least a portion of the circumference of the filter element and covered by the wrapping element. In other embodiments, the magnetic element may comprise a solid cylindrical shape operable to be enveloped by the filter element, the magnetic element having a diameter substantially smaller than a diameter of the filter element. In other embodiments, the magnetic element may comprise a flat rectangular shape operable to be inserted into an end of the filter element, providing a magnetic filter for previously manufactured cigarettes.

In other embodiments, the magnetic element may comprise a fiber shape operable to be integrated into the wrapping element (e.g., woven into the fibers of a rolling paper), or integrated into the filter element (e.g., integrated into the microporous or matrix-like composition of the filter element prior to forming the filter element).

In embodiments wherein the magnetic element comprises a thin, laminar shape, a method of using the magnetic filter device may comprise wrapping a magnetic element around at least a portion of an outer surface of a filter element, wrapping a wrapping element around the magnetic element and the filter element, and picking up the magnetic filter device with a magnet after use.

In embodiments wherein the magnetic element comprises a solid cylindrical shape, a method of using the magnetic filter device may comprise forming a filter element around a magnetic element such that the filter element envelops the magnetic element, wrapping a wrapping element around the filter element, and picking up the magnetic filter device with a magnet after use.

In embodiments wherein the magnetic element comprises a thin, rectangular shape, a method of using the magnetic filter device may comprise wrapping a wrapping element around a filter element, inserting a magnetic element into the filter element, and picking up the magnetic filter device with a magnet after use.

In embodiments wherein the magnetic element comprises a fiber shape, a method of using the magnetic filter device may comprise integrating a magnetic element into a wrapping element as the wrapping element is formed (e.g., adding the magnetic element to rolling paper pulp during processing), wrapping the wrapping element around a filter element, and picking up the magnetic filter device with a magnet after use.

In embodiments wherein the magnetic element comprises a fiber shape, a method of using the magnetic filter device may comprise integrating a magnetic element into a filter element as the filter element is formed (e.g., adding the magnetic element to the matrix material of the filter element prior to shaping the filter element) wrapping a wrapping element around the filter element, and picking up the magnetic filter device with a magnet after use.

In some embodiments, the present invention may comprise a magnetic filter device for use with a cigarette, the magnetic filter device comprising: a filter element for filtering smoke; a magnetic element operable to be attracted by a magnet; and a wrapping element to secure the filter element to the cigarette. In some embodiments, the magnetic element comprises a metal. In some embodiments, the metal comprises at least one of iron, nickel, cobalt, steel, or other similar magnetic alloy or composition. In some embodiments, the magnetic element comprises a thin, laminar shape operable to be wrapped around at least a portion of a circumference of the filter element. In some embodiments, the magnetic element is positioned between the circumference and the wrapping element. In some embodiments, the magnetic element comprises a solid, substantially cylindrical shape. In some embodiments, the magnetic element is entirely enveloped by the filter element, and the magnetic element comprises a diameter substantially smaller than a diameter of the filter element. In some embodiments, the magnetic element comprises a substantially flat, rectangular shape. In some embodiments, the magnetic element is operable to be inserted into an outer end of the filter element. In some embodiments, the magnetic element comprises a plurality of fibers. In some embodiments, the wrapping element comprises a fibrous rolling paper and the magnetic element is integrated into the fibrous rolling paper. In some embodiments, the filter element comprises a polymer material having a microporous composition and the magnetic element is integrated into the microporous composition. In some embodiments, the wrapping element comprises an adhesive for securing the wrapping element around the filter element. In some embodiments, the adhesive comprises a sugar gum.

In some embodiments, the present invention comprises a method of using the magnetic filter device described above, the method comprising the steps of: providing a cigarette having the magnetic filter device; and attracting the magnetic device with the magnet after use. In some embodiments, the magnetic element comprises a thin, laminar shape, and the method further comprises the steps of: wrapping the magnetic element around at least a portion of the circumference of the filter element; and wrapping the wrapping element around the magnetic element and the filter element. In some embodiments, the magnetic element comprises a solid, substantially cylindrical shape, and the method further comprises the steps of: forming the filter element around the magnetic element; and wrapping the wrapping element around the filter element. In some embodiments, the magnetic element comprises a flat, substantially rectangular shape, and the method further comprises the step of: inserting the magnetic element into the filter element. In some embodiments, the wrapping element comprises a fibrous rolling paper and the magnetic element comprises a plurality of fibers, and the method further comprises the step of: integrating the plurality of fibers into the fibrous rolling paper. In some embodiments, the filter element comprises a polymer material having a microporous composition and the magnetic element comprises a plurality of fibers, and the method further comprises the step of: integrating the plurality of fibers into the microporous composition.

It is an object of the present invention to provide a magnetic filter device which may be easily gathered and picked up from the ground after use without the need of a broom, a blower, or picking up the device up by hand.

It is also an object of the present invention to provide a magnetic filter device which may be easily gathered from uneven or loose ground after use.

It is also an object of the present invention to provide a magnetic filter device which can be manufactured via multiple methods.

It is also an object of the present invention to provide a magnetic filter device which may be integrated into previously manufactured cigarettes.

Additional aspects and objects of the invention will be apparent from the detailed descriptions and the claims herein.

### BRIEF DESCRIPTION OF THE DRAWINGS

FIG. 1 provides a perspective view of a magnetic filter device, according to an embodiment of the present invention.

FIG. 2 provides a perspective view of a magnetic filter device, according to an embodiment of the present invention.

FIG. 3 provides a perspective view of a magnetic filter device, according to an embodiment of the present invention.

FIG. 4 provides a perspective view of a magnetic filter device, according to an embodiment of the present invention.

FIG. 5 provides a perspective view of a magnetic filter device, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

Referring to the drawings wherein like reference characters designate like or corresponding parts throughout the several views, and referring to FIGS. 1-5, it is seen that the present invention includes various embodiments of a magnetic filter device.

The present invention relates to an improved apparatus and related methods for gathering discarded cigarette filters by providing a magnetic filter device which can be picked up via a magnet. The magnetic filter device may comprise a filter element, a wrapping element, and a magnetic element (e.g., a metal).

FIG. 1 provides a perspective view of a magnetic filter device 100, according to an embodiment of the present invention. The magnetic filter device 100 may comprise a filter element 110, a wrapping element 120, and a magnetic element 130. The wrapping element 120 is shown in a peeled back orientation in order to more clearly show the orientation of the magnetic element 130.

The filter element 110 may comprise a polymer material having a microporous or matrix-like composition, and a cylindrical shape.

The wrapping element 120 may comprise thin and lightweight paper made from non-wood plant fibers (e.g., flax, hemp, sisal, rice straw, or esparto), the paper having a porosity and a regulated burning rate suited to smoking tobacco. The wrapping element 120 may comprise an adhesive 121 on an edge thereof, the adhesive 121 being operable to hold the edge of the wrapping element 121 in place when wrapped about the filter element 110.

The magnetic element 130 may comprise a metal (e.g., iron, nickel, cobalt, steel, or other similar magnetic alloy or composition) having flat, thin laminar shape operable to be wrapped around at least a portion of the circumference of the filter element 110 and covered by the wrapping element 120.

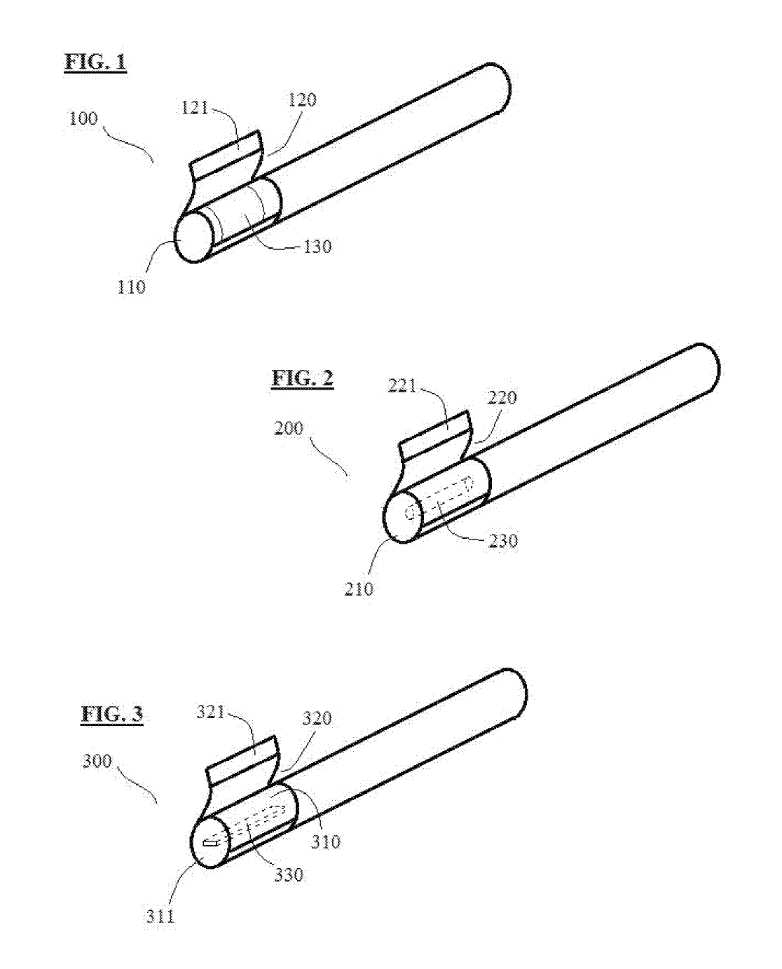

FIG. 2 provides a perspective view of a magnetic filter device 200, according to an embodiment of the present invention. The magnetic filter device 200 may comprise a filter element 210, a wrapping element 220 with an adhesive 221, and a magnetic element 230. The wrapping element 220 is shown in a peeled back orientation in order to more clearly show the orientation of the magnetic element 230.

The magnetic element 230 may comprise a solid cylindrical shape operable to be enveloped by the filter element 210, the magnetic element 230 having a diameter substantially smaller than a diameter of the filter element.

FIG. 3 provides a perspective view of a magnetic filter device 300, according to an embodiment of the present invention. The magnetic filter device 300 may comprise a filter element 310, a wrapping element 320 with an adhesive 321, and a magnetic element 330. The wrapping element 320 is shown in a peeled back orientation in order to more clearly show the orientation of the magnetic element 330. The magnetic element 330 may comprise a flat rectangular shape operable to be inserted into an outer end 311 of the filter element 330, providing a magnetic filter for previously manufactured cigarettes.

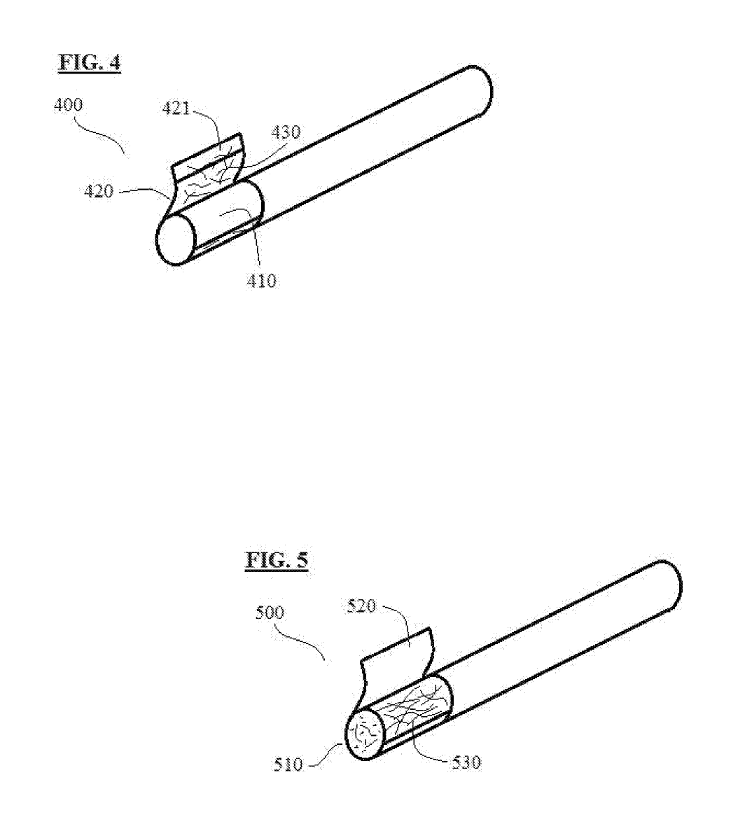

FIG. 4 provides a perspective view of a magnetic filter device 400, according to an embodiment of the present invention. The magnetic filter device 400 may comprise a filter element 410, a wrapping element 420 with an adhesive 421, and a magnetic element 430. The wrapping element 420 is shown in a peeled back orientation in order to more clearly show the orientation of the magnetic element 430. The wrapping element may comprise a fibrous rolling paper. The magnetic element 430 may comprise a plurality of metal fibers integrated into the fibrous rolling paper 420.

FIG. 5 provides a perspective view of a magnetic filter device 500, according to an embodiment of the present invention. The magnetic filter device 500 may comprise a filter element 510, a wrapping element 520 with an adhesive 521, and a magnetic element 530. The wrapping element 520 is shown in a peeled back orientation in order to more clearly show the orientation of the magnetic element 530. The filter element 510 may comprise a polymer material having a microporous composition, and the magnetic element 530 may comprise a plurality of fibers integrated into the microporous composition of the filter element 510.

It should be understood that the foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, and to thereby enable others skilled in the art to best utilize the invention and various embodiments with various modifications as are suited to the particular use contemplated.

What is claimed:

1. A magnetic filter device for use with a cigarette, comprising:
a. a filter element for filtering smoke;
b. a magnetic element operable to be attracted by a magnet; and
c. a wrapping element to secure said filter element to said cigarette.

2. The device of claim 1, wherein said magnetic element comprises a metal.

3. The device of claim 2, wherein said metal comprises at least one of iron, nickel, cobalt, steel, or other similar magnetic alloy or composition.

4. The device of claim 2, wherein said magnetic element comprises a thin, laminar shape operable to be wrapped around at least a portion of a circumference of said filter element.

5. The device of claim 4, wherein said magnetic element is positioned between said circumference and said wrapping element.

6. The device of claim 2, wherein said magnetic element comprises a solid, substantially cylindrical shape.

7. The device of claim 6, wherein said magnetic element is entirely enveloped by said filter element, said magnetic element comprising a diameter substantially smaller than a diameter of said filter element.

8. The device of claim 2, wherein said magnetic element comprises a substantially flat, rectangular shape.

9. The device of claim 8, wherein said magnetic element is operable to be inserted into an outer end of said filter element.

10. The device of claim 2, wherein said magnetic element comprises a plurality of fibers.

11. The device of claim 10, wherein said wrapping element comprises a fibrous rolling paper and said magnetic element is integrated into said fibrous rolling paper.

12. The device of claim 10, wherein said filter element comprises a polymer material having a microporous composition and said magnetic element is integrated into said microporous composition.

13. The device of claim 1, wherein said wrapping element comprises an adhesive for securing said wrapping element around said filter element.

14. The device of claim 13, wherein said adhesive comprises a sugar gum.

15. A method of using the device of claim 1, comprising the steps of:
a. providing a cigarette having said magnetic filter device; and
b. attracting said magnetic device with said magnet after use.

16. The method of claim 15, wherein said magnetic element comprises a thin, laminar shape, and further comprising the steps of:
a. wrapping said magnetic element around at least a portion of said circumference of said filter element; and
b. wrapping said wrapping element around said magnetic element and said filter element.

17. The method of claim 15, wherein said magnetic element comprises a solid, substantially cylindrical shape, and further comprising the steps of:
a. forming said filter element around said magnetic element; and
b. wrapping said wrapping element around said filter element.

18. The method of claim 15, wherein said magnetic element comprises a flat, substantially rectangular shape, and further comprising the step of:
a. inserting said magnetic element into said filter element.

19. The method of claim 15, wherein said wrapping element comprises a fibrous rolling paper and said magnetic element comprises a plurality of fibers, and further comprising the step of:
a. integrating said plurality of fibers into said fibrous rolling paper.

20. The method of claim 15, wherein said filter element comprises a polymer material having a microporous composition and said magnetic element comprises a plurality of fibers, and further comprising the step of:
a. integrating said plurality of fibers into said microporous composition.
